(19) United States
(12) Patent Application Publication
(10) Pub. No.: US 2005/0275788 A1
(43) Pub. Date: Dec. 15, 2005

(54) Method for fabricating an LC panel

(75) Inventor: Bo-Tsun Tsai, Taipei (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Arima Computer Corporation, Taipei (TW)

(21) Appl. No.: 10/867,475

(22) Filed: Jun. 14, 2004

(51) Int. Cl. G02F 1/13

(52) U.S. Cl. 349/187

(57) ABSTRACT

A method for fabricating a liquid crystal (LC) panel is provided. The method includes steps of: (a) providing a backplane having an alignment layer thereon, wherein the alignment layer has a plurality of marks thereon; (b) forming a side frame on the alignment layer, wherein the side frame has at least one slit; (c) removing a contamination covering the marks under vacuum; (d) forming a transparent conductive layer on the alignment layer; (e) filling a gap between the alignment layer and the transparent conductive layer with a liquid crystal; and (f) sealing the slit.

### FIELD OF THE INVENTION

The present invention relates to a method for fabricating a liquid crystal (LC) panel, and more specifically, to a method for improving the efficiency of the fabricating process of an LC panel.

### BACKGROUND OF THE INVENTION

With the proceeding of modern manufacturing technologies, a liquid crystal display (LCD) has been in widespread use. The operation principles of the LCD are that using an electric field to control the arrangement of liquid crystal molecules and displaying brilliant or dark images by the beams of the backlight which have passed the liquid crystal molecules or not.

Please refer to FIG. 1 (a) to FIG. 1 (e), which shows a method for fabricating an LC panel according to the prior art. As shown in FIG. 1 (a), a backplane 10 including multiple arrayed electrodes (not shown) positioned on the backplane 10 is provided. Then an alignment process, a cleaning process, a gasket seal coating process, a spacer ball spraying process, and a combination process are performed sequentially. The details are as follows:

(1) The Alignment Process.

The method begins with coating an alignment layer 11 on the backplane 10. As shown in FIG. 1 (b), a rubbing process is performed to form multiple alignment trenches 12 on the alignment layer 11. Normally, the backplane 10 is a silicon backplane, and the rubbing process is performed on a surface of the alignment layer 11 and utilizes a rubbing cloth.

(2) The Cleaning Process.

A chemical solvent is then utilized to clean the contamination and impurities on the backplane 10, the alignment layer 11, and their peripheries which are produced during the cleaning process.

(3) The Gasket Seal Coating Process.

As shown in FIG. 1 (c), a mixture including a gasket seal and multiple spacer balls, compose of glass, is then coated on a border of the alignment layer 11 to form a side frame 14, including at least one slit 15, to surround the multiple electrodes. A curing process is performed to reinforce the hardness of the side frame 14.

(4) The Spacer Ball Spraying Process.

As shown in FIG. 1 (d), multiple spacer balls 13 are sprayed on the alignment layer 11, wherein a distance between two adjacent spacers 13 ranges from 50 to 400 microns on the product requirement.

(5) The Combination Process.

As shown in FIG. 1(e), a gasket seal is then coated on the side frame 14 and the multiple photoresist (PR) spacers 13. By performing a lamination process, a transparent conductive layer 16, including indium tin oxide (ITO), and a transparent glass (not shown) are laminated, in order, on the backplane 10. A liquid crystal filling (LC filling) process is then performed to fill a cell gap between the backplane 10 and the transparent conductive layer 16 with liquid crystal. Finally, an end sealing process is performed to seal the slit 15, and a realignment process is performed after the end sealing process.

A method for fabricating an LC panel to prevent spacer collapse or slide due to the inconsistency of the spacer size according to U.S. Pat. No. 6,669,520. The same with the prior art, U.S. Pat. No. 6,669,520 has some disadvantages as follows. For the convenience of the manufacturing process of the LC panel, special marks for adjusting are frequently utilized on the alignment layer 11. However, the marks are sometimes covered with the contamination or the impurities produced by the manufacturing environment, the manufacturing machines, or the materials. It leads to the low efficiency of the combination process (especially for the combination process of the transparent conductive layer 16 and the transparent glass). The yield of the automatic fabricating process may be under 50% for the cause.

To solve the problem, several solutions have been provided with limited effects:

(a) Performing a Part-Alignment Process Instead of the Alignment Process.

The characteristic of the part-alignment process is to form part of the alignment trenches and keep away from the trenches around the marks, or to cover the marks and proceed the following processes. However, following the alignment process, the contamination or the impurities may still be produced again.

(b) Adding a Wiping Process in the Cleaning Process.

The characteristic of the wiping process is to wipe contamination off the marks with a wiping machine and to proceed with the following processes. However, following the cleaning process, the contamination or the impurities may still be produced again.

It is therefore attempted by the applicant to deal with the above situation encountered in the prior art.

### SUMMARY OF THE INVENTION

It is the main object of the present invention to provide a method for fabricating an LC panel. The method is characterized by an additional vacuum removing process between the spacer ball spraying process and the combination process, which is utilized to remove the contamination or the impurities which have covered the marks for adjusting, produced by the manufacturing environment, the manufacturing machines, or the materials, so as to improve the efficiency of the following processes.

According to one aspect of the present invention, the method for fabricating a liquid crystal (LC) panel includes steps of: (a) providing a backplane having an alignment layer thereon, wherein the alignment layer has a plurality of marks thereon; (b) forming a side frame on the alignment layer, wherein the side frame has at least one slit; (c) removing a contamination covering the marks under vacuum; (d) forming a transparent conductive layer on the alignment layer; (e) filling a gap between the alignment layer and the transparent conductive layer with a liquid crystal; and (f) sealing the slit.

According to another aspect of the present invention, the method for fabricating a liquid crystal (LC) panel includes steps of: (a) providing a backplane having an alignment layer thereon, wherein the alignment layer has a plurality of marks thereon; (b) forming a side frame on the alignment layer; (c) removing a contamination covering the marks under vacuum; (d) forming a transparent conductive layer on the alignment layer; and (e) filling a gap between the alignment layer and the transparent conductive layer with a liquid crystal.

Preferably, between the step (a) and the step (b) further includes steps of: performing a rubbing process to form a plurality of alignment trenches on the alignment layer, and cleaning the backplane, the alignment layer and a periphery thereof, and the marks.

Preferably, the backplane further includes a plurality of arrayed electrodes surrounded by the side frame.

Preferably, the step (b) further includes a step of: forming a plurality of spherical spacers on the alignment layer and within the side frame.

Preferably, the step (b) includes performing a lithography process with a photoresist to form the side frame and a plurality of the spherical spacers.

Preferably, between the step (b) and the step (c) further includes a step of: curing the side frame and a plurality of the spherical spacers to reinforce a hardness of both the side frame and a plurality of the spherical spacers.

Preferably, between the step (c) and the step (d) further includes a step of: forming a gasket seal on the side frame and a plurality of the spherical spacers.

Preferably, the step (c) is performed by an automatic backplane-fabrication machine.

Preferably, the transparent conductive layer is made of indium tin oxide (ITO).

Preferably, the method further includes a step of: realigning the liquid crystal which is filled in the panel.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 (a) to (e) are cross-section views of fabricating an LC panel according to the prior art;

FIG. 2 (a) to (e) are cross-section views of fabricating an LC panel according to the present invention; and

FIG. 3 is a table showing the comparison of the products produced by the LC panel fabrication methods between the prior art and the present invention.

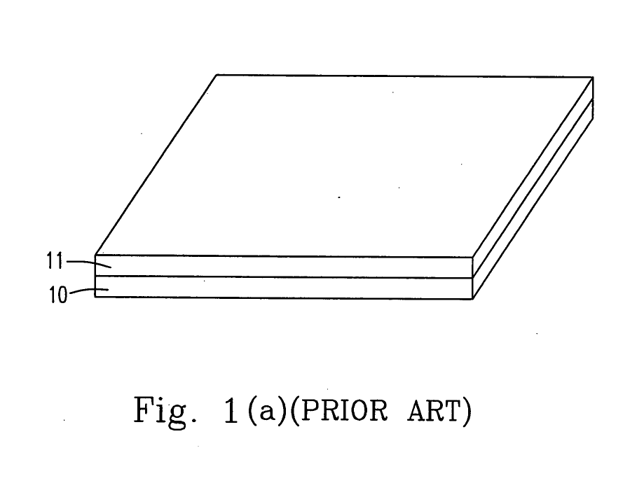

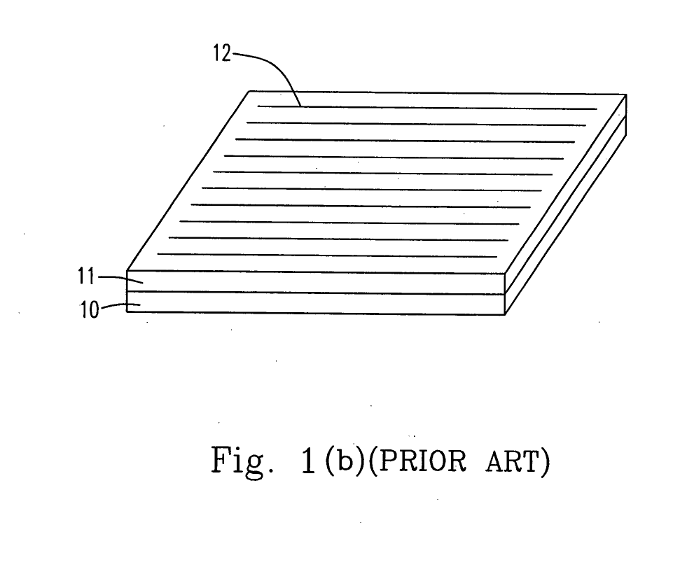

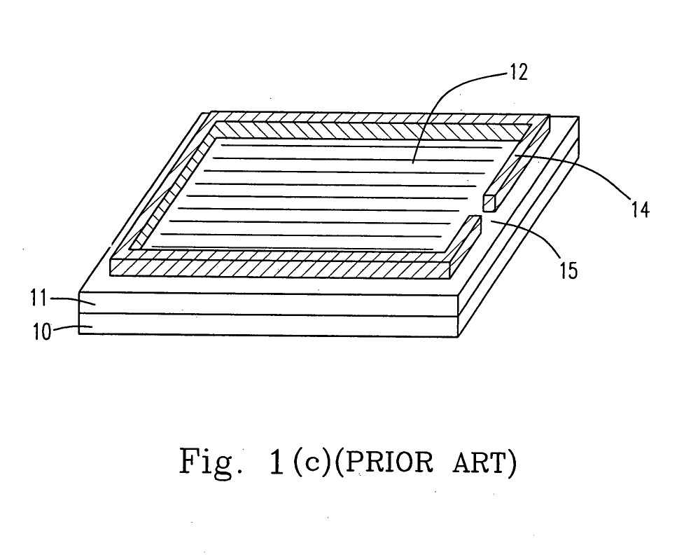

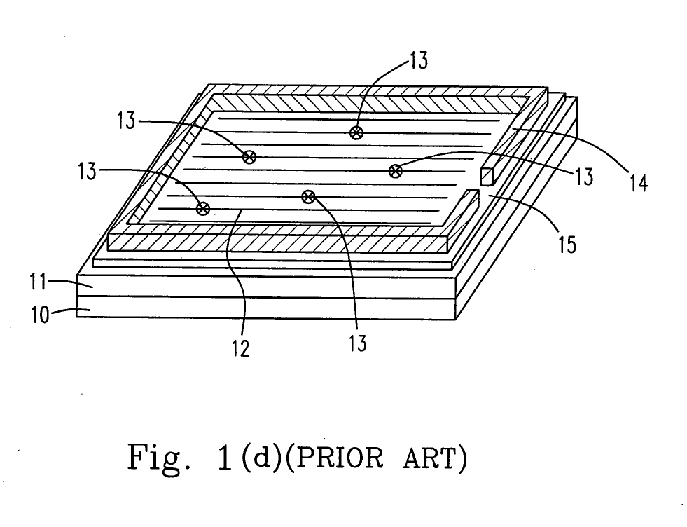

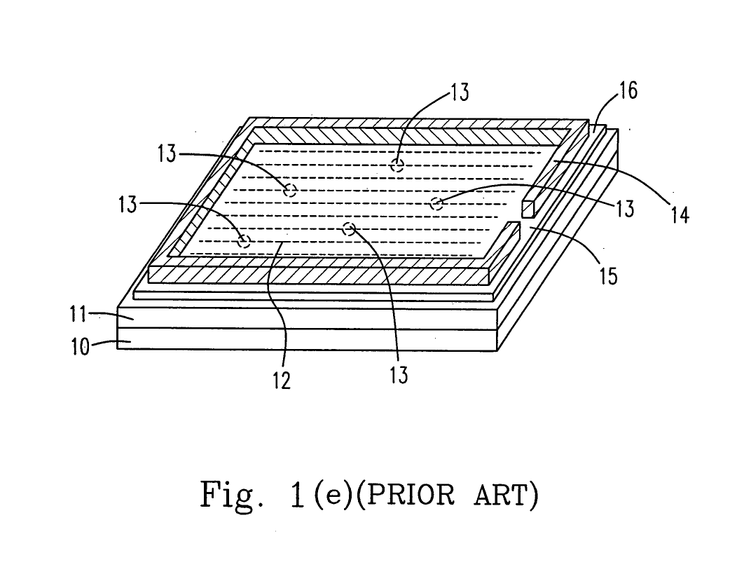

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

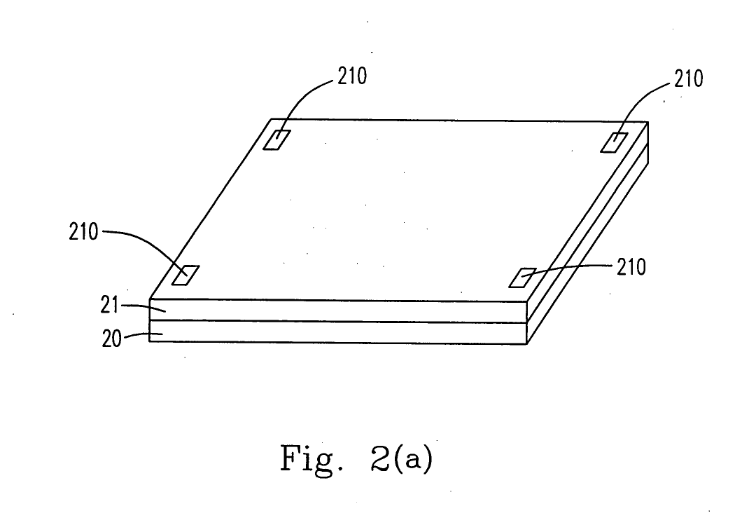

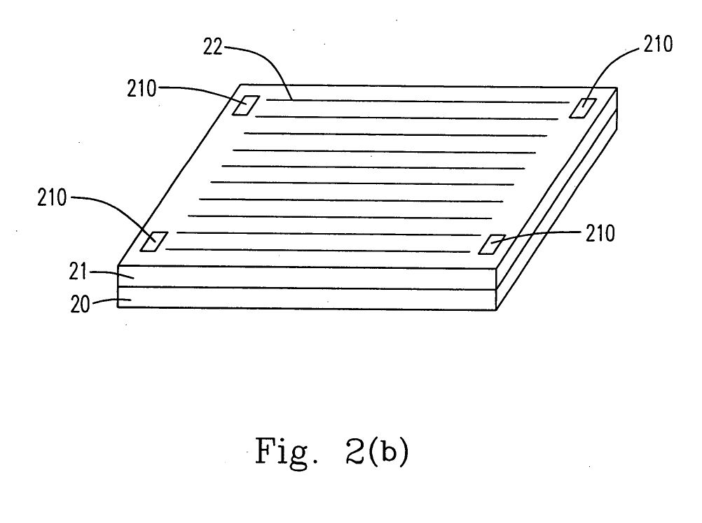

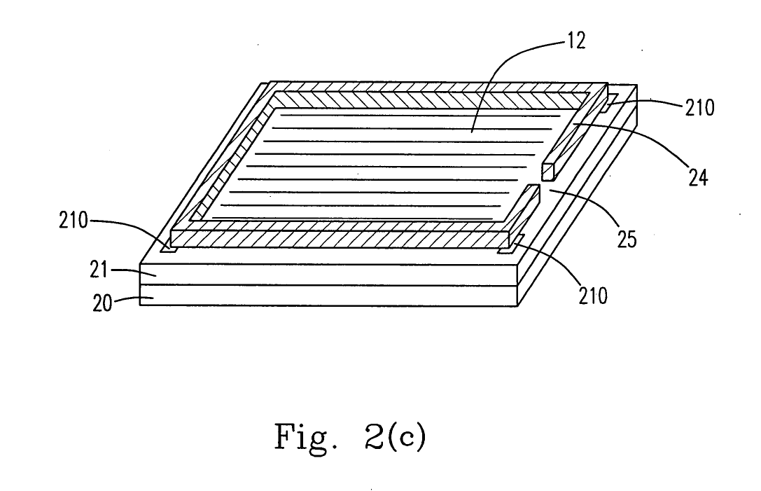

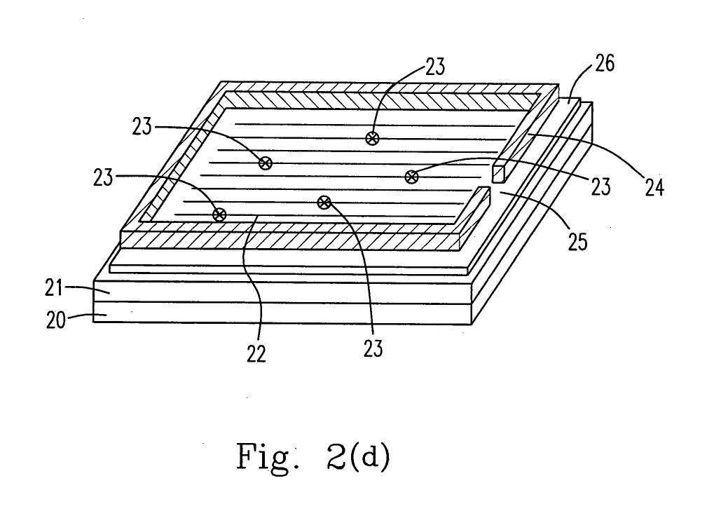

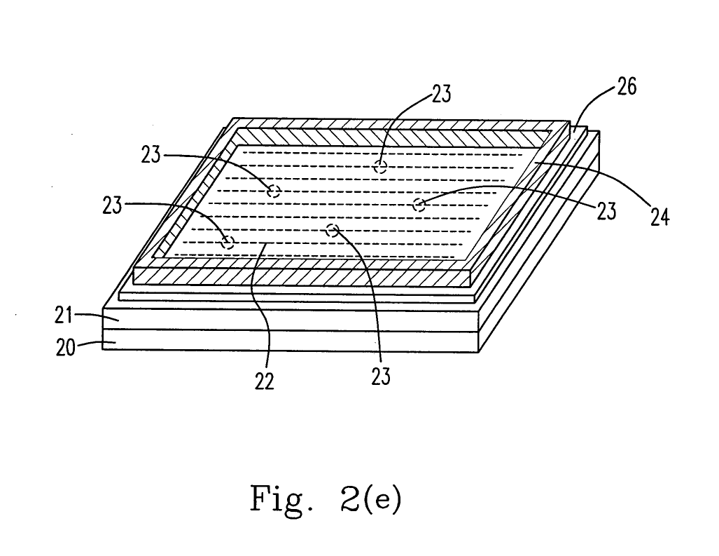

Please refer to FIG. 2 (a) to FIG. 2 (e), which show a method for fabricating an LC panel according to the present invention. As shown in FIG. 2 (a), a backplane 20 including multiple arrayed electrodes (not shown) positioned on the backplane 20 is provided. Then an alignment process, a cleaning process, a gasket seal coating process, a spacer ball spraying process, a vacuum removing process, and a combination process are performed sequentially. The details are as follows:

(1) The Alignment Process.

The method begins with coating an alignment layer 21 on the backplane 20. There are several marks formed on the alignment layer 21. As shown in FIG. 2 (b), a rubbing process is performed to form multiple alignment trenches 22 on the alignment layer 21. Normally, the backplane 20 is a silicon backplane, and the rubbing process is performed on a surface of the alignment layer 21 and utilizes a rubbing cloth.

(2) The Cleaning Process.

A chemical solvent is then utilized to clean the contamination and impurities on the backplane 20, the alignment layer 21, and their peripheries which are produced during the cleaning process.

(3) The Gasket Seal Coating Process.

As shown in FIG. 2 (c), a mixture including a gasket seal and multiple spacer balls, compose of glass, is then coating on a border of the alignment layer 21 to form a side frame 24, including at least one slit 25, to surround the multiple electrodes. A curing process is performed to reinforce the hardness of the side frame 24.

(4) The Spacer Ball Spraying Process.

As shown in FIG. 2 (d), multiple spacer balls 23 are sprayed on the alignment layer 21, wherein a distance between two adjacent spacers 23 ranges from 50 to 400 microns, depending upon the quantity required of the spacer balls 23. The more the spacer balls 23 are, the smaller the distance is.

An alternative process can also be performed instead of the gasket seal coating process and the spacer ball spraying process. That is, forming the side frame 24 and a plurality of the spacers, not necessarily spherical, with a lithography process after forming a photoresist layer on the alignment layer 21 formed in the alignment process.

(5) The Vacuum Removing Process.

The vacuum removing process can be performed to remove under vacuum the contamination and the impurities which are produced in the former processes and have covered the marks 210 by an automatic machine so as to make the following combination process proceed fluently.

(6) The Combination Process.

As shown in FIG. 2 (e), a gasket seal is then coated on the side frame 24 and the multiple PR spacers 23. By performing a lamination process, a transparent conductive layer 26, including indium tin oxide (ITO), and a transparent glass (not shown) are laminated, in order, on the backplane 20. An LC filling process is then performed to fill a cell gap between the backplane 20 and the transparent conductive layer 26 with liquid crystal. Finally, an end sealing process is performed to seal the slit 25, and a realignment process is performed after the end sealing process.

Although the former processes are performed with the side frame 24 with the slit 25, it is still practicable to perform them with a side frame without any slits. That is to say, the present invention can also be utilized in the modern fabrication process of an LC panel, in which a slit is not necessary any more.

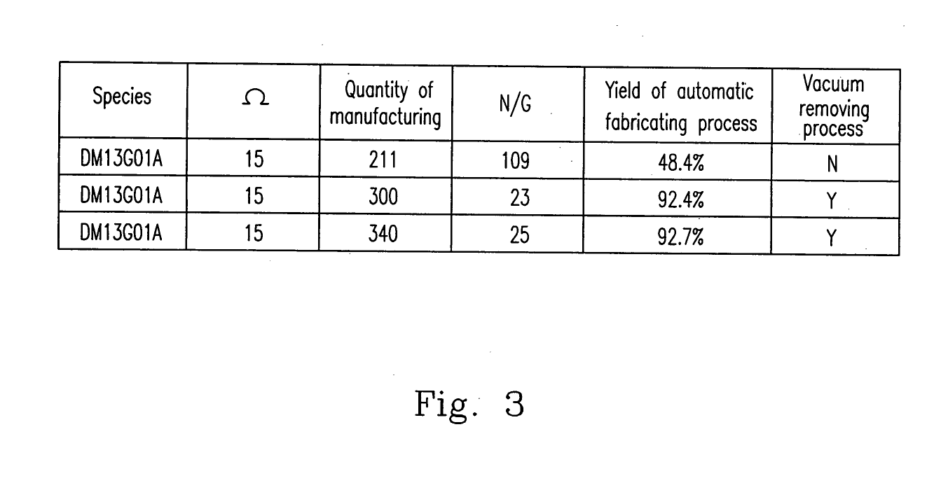

Please refer to FIG. 3, which is a table showing the comparison of the products produced by the LC panel fabrication methods between the prior art and the present invention. From the table, it can be seen that, for the same species of the LC panel, the yield of the automatic fabricating process with the vacuum removing process is twice as high as the yield of the traditional process without the vacuum removing process. Therefore, the present invention is indeed a great contribution toward the LC panel fabrication process.

Another advantage of the present invention is no additional cost. An automatic backplane-fabrication machine can be utilized to perform the vacuum removing process, which result in no need of the purchase of new machines.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

1. A method for fabricating a liquid crystal (LC) panel, comprising steps of:
(a) providing a backplane having an alignment layer thereon, wherein said alignment layer has a plurality of marks thereon;
(b) forming a side frame on said alignment layer, wherein said side frame has at least one slit;
(c) removing a contamination covering said plurality of marks under vacuum;
(d) forming a transparent conductive layer on said alignment layer;
(e) filling a gap between said alignment layer and said transparent conductive layer with a liquid crystal; and
(f) sealing said slit.

2. The method according to claim 1, between said step (a) and said step (b) further comprising steps of: performing a rubbing process to form a plurality of alignment trenches on said alignment layer, and cleaning said backplane, said alignment layer and a periphery thereof, and said plurality of marks.

3. The method according to claim 1, wherein said backplane further comprises a plurality of arrayed electrodes surrounded by said side frame.

4. The method according to claim 1, wherein said step (b) further comprises a step of: forming a plurality of spherical spacers on said alignment layer and within said side frame.

5. The method according to claim 4, wherein said step (b) comprises performing a lithography process with a photoresist to form said side frame and said plurality of spherical spacers.

6. The method according to claim 4, between said step (b) and said step (c) further comprising a step of: curing said side frame and said plurality of spherical spacers to reinforce a hardness of both said side frame and said plurality of spherical spacers.

7. The method according to claim 4, between said step (c) and said step (d) further comprising a step of: forming a gasket seal on said side frame and said plurality of spherical spacers.

8. The method according to claim 1, wherein said step (c) is performed by an automatic backplane-fabrication machine.

9. The method according to claim 1, wherein said transparent conductive layer is made of indium tin oxide (ITO).

10. The method according to claim 1, further comprising a step of: realigning said liquid crystal which is filled in said panel.

11. A method for fabricating a liquid crystal (LC) panel, comprising steps of:
(a) providing a backplane having an alignment layer thereon, wherein said alignment layer has a plurality of marks thereon;
(b) forming a side frame on said alignment layer;
(c) removing a contamination covering said plurality of marks under vacuum;
(d) forming a transparent conductive layer on said alignment layer; and
(e) filling a gap between said alignment layer and said transparent conductive layer with a liquid crystal.

12. The method according to claim 1, between said step (a) and said step (b) further comprising steps of: performing a rubbing process to form a plurality of alignment trenches on said alignment layer, and cleaning said backplane, said alignment layer and a periphery thereof, and said plurality of marks.

13. The method according to claim 11, wherein said backplane further comprises a plurality of arrayed electrodes surrounded by said side frame.

14. The method according to claim 11, wherein said step (b) further comprises a step of: forming a plurality of spherical spacers on said alignment layer and within said side frame.

15. The method according to claim 14, wherein said step (b) comprises performing a lithography process with a photoresist to form said side frame and said plurality of spherical spacers.

16. The method according to claim 14, between said step (b) and said step (c) further comprising a step of: curing said side frame and said plurality of spherical spacers to reinforce a hardness of both said side frame and said plurality of spherical spacers.

17. The method according to claim 14, between said step (c) and said step (d) further comprising a step of: forming a gasket seal on said side frame and said plurality of spherical spacers.

18. The method according to claim 11, wherein said step (c) is performed by an automatic backplane-fabrication machine.

19. The method according to claim 11, wherein said transparent conductive layer is made of indium tin oxide (ITO).

20. The method according to claim 11, further comprising a step of: realigning said liquid crystal which is filled in said panel.
